(19) United States
(12) Patent Application Publication
(10) Pub. No.: US 2024/0329815 A1
(43) Pub. Date: Oct. 3, 2024

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Takeshi HORIGUCHI, Kanagawa (JP)

(73) Assignee: FUJIFILM Business Innovation Corp., Tokyo (JP)

(21) Appl. No.: 18/456,511

(22) Filed: Aug. 27, 2023

(30) Foreign Application Priority Data
Mar. 28, 2023 (JP) 2023-052423

(51) Int. Cl. G06F 3/04842; G06F 3/04845

(52) U.S. Cl. CPC G06F 3/04842; G06F 3/04845; G06F 2203/04108

(57) ABSTRACT

An information processing system includes a processor configured to, when an object in a screen is to be operated with a target in a contactless manner, accept an operation on the object that is in a selected state in response to the target being located in a second region closer to the screen than a first region among multiple regions separated according to a distance from the screen, the first region being assigned an operation for selecting the object in the screen, the second region being assigned an operation on the object.

### CROSS-REFERENCE TO RELATED APPLICATIONS

This application is based on and claims priority under 35 USC 119 from Japanese Patent Application No. 2023-052423 filed Mar. 28, 2023.

### BACKGROUND

### (i) Technical Field

The present disclosure relates to an information processing system, an information processing method, and a non-transitory computer readable medium.

### (ii) Related Art

Japanese Unexamined Patent Application Publication No. 2015-148960 discloses an information processing apparatus including position determination means for determining a position on a display surface of a display unit that displays information, the position on the display surface corresponding to the position of an operating object that is not in contact with the display surface and that is detected in a mid-air area close to the display surface; operation identification means for identifying an input operation based on a predetermined motion of the operating object detected in the mid-air area, and execution means for executing a predetermined process in accordance with the position determined by the position determination means and the input operation identified by the operation identification means.

### SUMMARY

Aspects of non-limiting embodiments of the present disclosure relate to prevention or reduction of the occurrence of erroneous operations on an object in a screen to be operated with a target in a contactless manner, compared to when an operation on an object that is not in a selected state is accepted.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to, when an object in a screen is to be operated with a target in a contactless manner, accept an operation on the object that is in a selected state in response to the target being located in a second region closer to the screen than a first region among a plurality of regions separated according to a distance from the screen, the first region being assigned an operation for selecting the object in the screen, the second region being assigned an operation on the object.

### BRIEF DESCRIPTION OF THE DRAWINGS

An exemplary embodiment of the present disclosure will be described in detail based on the following figures, wherein:

FIG. 1 is a diagram illustrating an example configuration of an information processing system including a contactless user interface through which a user performs an operation in a contactless manner;

FIG. 2 is a perspective view of a substantial part of an image processing apparatus according to an exemplary embodiment;

FIG. 3A is a sectional view of an operation panel;

FIG. 3B is a plan view of the operation panel when viewed in a direction facing a display surface of the operation panel;

FIG. 4 is a diagram illustrating an example functional configuration of the image processing apparatus according to the exemplary embodiment;

FIG. 5 is a diagram illustrating an example transition of a screen displayed on the operation panel, presenting how the screen transitions in response to the user operating the operation panel;

FIG. 6 is a diagram illustrating an example in which the user selects a “Copy” button, which is an example of an object, on a home screen;

FIG. 7 is a block diagram illustrating an example configuration of a substantial part of an electrical system of the image processing apparatus according to the exemplary embodiment;

FIG. 8 is a front view of a print screen on the operation panel when viewed from the front, illustrating objects in the print screen;

FIG. 9 is a side view of the operation panel, schematically illustrating an example of a plurality of regions in mid-air above the operation panel when the operation panel is viewed from a side;

FIG. 10 is a side view corresponding to FIG. 9, illustrating a state in which a target used for contactless operation is in a first region above the print screen;

FIG. 11 is a front view corresponding to FIG. 8, illustrating a state in which one of the objects in the print screen is tentatively selected;

FIG. 12 is a front view corresponding to FIG. 8, illustrating a state in which another object in the print screen is tentatively selected;

FIG. 13 is a front view corresponding to FIG. 8, illustrating an operation for changing the print screen to the next page;

FIG. 14 is a side view corresponding to FIG. 9, illustrating a state in which the target used for contactless operation is in a second region above the print screen;

FIG. 15 is a front view corresponding to FIG. 8, illustrating a state in which one of the objects in the print screen is selected;

FIG. 16 is a front view corresponding to FIG. 8, illustrating a state in which the target used for contactless operation is moved to above an unselected object in the print screen;

FIG. 17 is a front view corresponding to FIG. 8, illustrating a state in which unselected objects in the print screen are displayed in a different color;

FIG. 18 is a side view corresponding to FIG. 9, illustrating an operation for moving the target used for contactless operation from the second region to the first region;

FIG. 19 is a front view corresponding to FIG. 8, illustrating an operation for tentatively selecting an object different from a selected object when the target used for contactless operation is present in the first region;

FIG. 20 is a front view corresponding to FIG. 8, illustrating an operation for changing the print screen to the next page after an object is selected;

FIG. 21 is a front view corresponding to FIG. 8, illustrating an operation for canceling the selection of an object and bringing another object into a selected state when the target used for contactless operation is present in the second region;

FIG. 22 is a front view corresponding to FIG. 8, illustrating an operation for moving the target used for contactless operation along the print screen from one side to another of the print screen;

FIG. 23 is a side view corresponding to FIG. 9, illustrating the first region and the second region when the target used for contactless operation comes into close proximity to the print screen from one side to another of the print screen;

FIG. 24 is a flowchart illustrating an example of a process for contactless operation based on an information processing program according to the exemplary embodiment;

FIG. 25 is a flowchart illustrating an example of a first region control process illustrated in FIG. 24;

FIG. 26 is a flowchart illustrating an example of a second region control process illustrated in FIG. 24; and

FIG. 27 is a side view of the operation panel, schematically illustrating an example of a plurality of regions in mid-air above the operation panel when the operation panel is viewed from a side.

### DETAILED DESCRIPTION

The following describes an exemplary embodiment of the present disclosure in detail with reference to the drawings. Components and processes that have substantially the same operations and functions are assigned the same reference symbols throughout the drawings, and redundant descriptions thereof may be omitted. The drawings are merely presented in schematic form to allow a full understanding of the present disclosure. Therefore, the present disclosure is not limited to only the illustrated examples. In the present exemplary embodiment, descriptions of configurations that are not directly related to the present disclosure or are well known may be omitted.

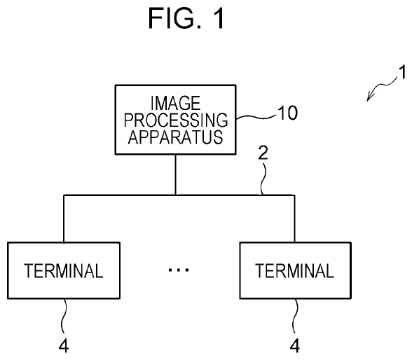

FIG. 1 is a diagram illustrating an example configuration of an information processing system 1 including an information processing apparatus having a contactless user interface through which a user performs an operation in a contactless manner.

The information processing apparatus in the information processing system 1 may be applied to any field as long as the information processing apparatus has a contactless user interface. Examples of the information processing apparatus include an image processing apparatus, an automatic teller machine (ATM), a vending machine, and an automatic ticket dispenser. The information processing apparatus may be for personal use only or usable by an unspecified number of users.

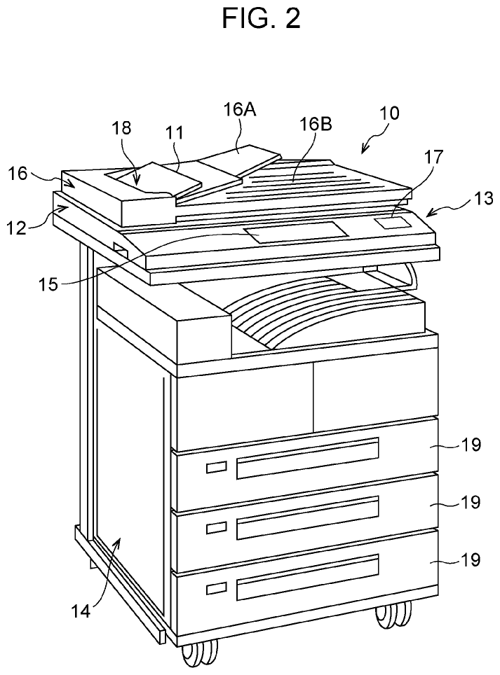

An image processing apparatus 10 installed in a workplace as an example of the information processing apparatus will be described hereinafter with reference to FIGS. 1 and 2.

FIG. 2 is a perspective view of a substantial part of the image processing apparatus 10 according to the present exemplary embodiment.

As described below, the image processing apparatus 10 is configured to execute functions related to images in accordance with instructions from users. The image processing apparatus 10 is connected to, for example, a plurality of terminals 4 to be used by individual users via a communication line 2.

Each user transmits image data generated by a corresponding one of the terminals 4 to the image processing apparatus 10 through the communication line 2 to cause the image processing apparatus 10 to execute desired image processing. Alternatively, a user may bring a portable storage medium such as a Universal Serial Bus (USB) memory or a memory card storing image data to the image processing apparatus 10 and connect the portable storage medium to the image processing apparatus 10 to cause the image processing apparatus 10 to execute desired image processing. Alternatively, a user may bring a document 11 having at least one of text or an image to the image processing apparatus 10 and make the image processing apparatus 10 read the document 11 to cause the image processing apparatus 10 to execute desired image processing.

The communication line 2 may be of any type that provides a connection between the image processing apparatus 10 and the terminals 4, such as a wired connection, a wireless connection, or a combination of wired and wireless connections. In addition, any number of terminals 4 may be connected to the image processing apparatus 10. For example, none of the terminals 4 may be connected to the image processing apparatus 10.

The terminals 4 are information devices configured to be used by users. The terminals 4 may be any type of information device having a data storage function and a data communication function. The terminals 4 include, for example, computers intended to be used at fixed positions, and mobile terminals intended to be transported and used, such as smartphones and wearable devices.

As illustrated in FIG. 2, the image processing apparatus 10 has, for example, a scan function for reading an image on a recording medium such as paper as image data, a print function for forming an image represented by image data on a recording medium, and a copy function for forming the same image as an image formed on a recording medium onto another recording medium. The copy function, the print function, and the scan function are examples of image processing to be performed by the image processing apparatus 10.

The image processing apparatus 10 illustrated in FIG. 2 includes, for example, a document reading device 12 in an upper portion thereof, and an image forming device 14 below the document reading device 12.

The document reading device 12 includes an optical reading device (not illustrated) and a document transport device 18. The document transport device 18 is disposed in a document cover 16. The document cover 16 is provided with a document table 16A, on which documents 11 are placed. The document transport device 18 sequentially feeds each of the documents 11 on the document table 16A and transports the document 11 onto a transported-document scanning glass (not illustrated). The document reading device 12 reads the content of the document 11 transported onto the transported-document scanning glass as image data using the optical reading device. Thereafter, the document transport device 18 discharges the document 11 whose content has been read onto a discharge table 16B included in the document cover 16.

The image forming device 14 forms an image represented by image data on a recording medium. Recording media are stored in storage trays 19 that are classified by the type or size of recording media. The image forming device 14 may form an image in any color on a recording medium and may form a color image or a monochrome image.

The image processing apparatus 10 includes, in a front portion thereof, an operation display device 13 that accepts an operation for executing various functions such as the copy function, the print function, and the scan function from a user.

Specifically, the operation display device 13 includes a reader device 17 that acquires information on a user who performs an operation, and an operation panel 15 that accepts an operation performed by the user.

For example, in response to the user bringing their employee identity card close to the reader device 17, the reader device 17 reads identification information (referred to as a “user ID”) for uniquely identifying the user from an integrated circuit (IC) chip incorporated in the employee identity card in a contactless manner.

The operation panel 15 is a display having a touch panel superimposed thereon. The operation panel 15 displays, as an icon image, an object to be operated by the user to execute a desired function. The object may be of any type that is to be operated by the user, and includes, for example, a button, a scroll bar, a check box, and a radio button. In response to the user performing an operation on the object, the image processing apparatus 10 executes a process associated in advance with the content of the operation, and a response to the operation is displayed on the operation panel 15.

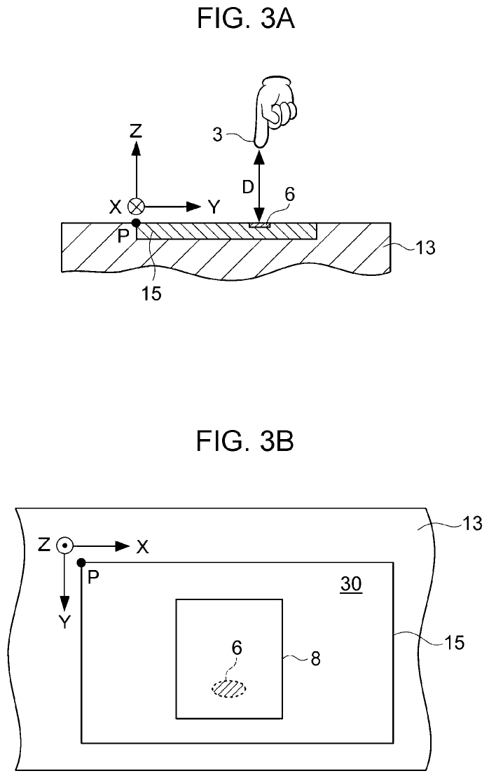

FIGS. 3A and 3B illustrate an example of the operation panel 15 that allows detection of an operation position 6 of the user in a contactless manner. FIG. 3A is a sectional view of the operation panel 15, and FIG. 3B is a plan view of the operation panel 15 when viewed in a direction facing a display surface of the operation panel 15.

The operation panel 15 detects the position of the user's finger, that is, the operation position 6, in a contactless manner. The phrase “detecting the operation position 6 in a contactless manner” refers to detecting the position of a user's finger in response to the user holding their finger in a position in mid-air that is above a display surface of the operation panel 15 and that is away from the display surface of the operation panel 15 in a range of the display surface of the operation panel 15 without pressing their finger against the display surface of the operation panel 15. A mid-air space above the display surface of the operation panel 15 in a range of the display surface of the operation panel 15 is hereinafter referred to as a mid-air space “over the operation panel 15” or “above the operation panel 15”. The phrase “holding the user's finger over something (such as the operation panel 15)” means that the user points at a position in mid-air over the operation panel 15 with their finger without touching the display surface of the operation panel 15.

The operation panel 15 includes a so-called capacitive touch panel that detects the operation position 6 from a change in electrostatic capacitance caused by the user holding their finger over the operation panel 15. In the operation panel 15 including such a touch panel, a change in electrostatic capacitance at a position closest to the user's finger is larger than a change in electrostatic capacitance at any other position. Accordingly, the operation panel 15 outputs, as the operation position 6 of the user, a position at which the change in electrostatic capacitance is largest within the range of the operation panel 15.

To identify the operation position 6 of the user on the operation panel 15, an operation coordinate system is defined for the operation panel 15 to define a detection area for contactless detection of the position of the user's finger. The operation coordinate system is represented as a three-dimensional coordinate system having any position on the operation panel 15 as an origin P. In the example of the operation panel 15 illustrated in FIGS. 3A and 3B, the origin Pis set at one of the vertices of the outline of the rectangular operation panel 15. In the example of the operation panel 15 illustrated in FIGS. 3A and 3B, furthermore, an X axis is set along a lateral direction of the operation panel 15 with respect to the origin P, a Y axis is set along a longitudinal direction of the operation panel 15 with respect to the origin P, and a Z axis is set so as to be orthogonal to the X and Y axes. The Z-axis direction is referred to as a height direction of the operation panel 15.

The operation position 6 of the user on the operation panel 15 is represented by a coordinate point (x, y), which is a combination of the coordinate value x of the X coordinate and the coordinate value y of the Y coordinate of a position at which the change in electrostatic capacitance is largest within the range of the operation panel 15.

When the operation panel 15 displays objects, an object displayed so as to include the operation position 6 of the user is recognized as the object being operated by the user. In the example of the operation panel 15 illustrated in FIG. 3B, since the operation position 6 of the user is included in the area of a button 8 in a screen 30 displayed on the operation panel 15, the user is recognized as operating the button 8. An object displayed so as to include the operation position 6 of the user may be hereinafter referred to as an “object corresponding to the operation position 6”. The operation position 6 is an example of a “detected position at which an operation performed by a user has been detected” according to the present exemplary embodiment.

As illustrated in FIG. 3A, the length of a perpendicular drawn from a user's finger 3, which is held over the operation panel 15, to the display surface of the operation panel 15, that is, the distance from the user's finger 3 to the operation panel 15 in the height direction of the operation panel 15, is represented by an “operation distance D”. The user's finger 3 is an example of a target with which the user performs operations. The target may be a body part of the user, other than the user's hand or fingers, or may be a stylus or any other tool owned by the user. As the operation distance D decreases, the change in electrostatic capacitance at the operation position 6 of the user increases on the operation panel 15. Conversely, as the operation distance D increases, the change in electrostatic capacitance at the operation position 6 of the user decreases on the operation panel 15. Accordingly, associating the operation distance D with the amount of change in electrostatic capacitance in advance makes it possible to obtain the operation distance D from the amount of change in electrostatic capacitance on the operation panel 15.

Based on the correspondence relationship between the operation distance D and the amount of change in electrostatic capacitance, the operation panel 15 recognizes the operation position 6 of the user not only as a two-dimensional operation position 6 along the display surface of the operation panel 15 but also as a three-dimensional operation position 6 that takes the operation distance D into account. That is, when the operation position 6 of the user is represented as a three-dimensional position, the operation position 6 of the user is represented by a coordinate point (x, y, z) obtained by combining a coordinate value z representing the operation position 6 in the height direction of the operation panel 15 with the coordinate point (x, y). The coordinate value z is a coordinate value, on the Z axis, of a position the operation distance D away from the origin P along the Z axis.

The coordinate value z=0 means that the user is performing an operation while touching the display surface of the operation panel 15 with their finger. Accordingly, the image processing apparatus 10 also recognizes a difference in the manner of the operation of the user, such as whether the user is operating the operation panel 15 in a contactless manner or operating the operation panel 15 with their finger in contact with the operation panel 15. As described above, the operation panel 15 supports both a contact operation in which the user performs an operation while touching the display surface of the operation panel 15 with their finger and a contactless operation in which the user operates the operation panel 15 while holding their finger over the operation panel 15.

As described above, since the change in electrostatic capacitance at the operation position 6 of the user decreases on the operation panel 15 as the operation distance D increases, the operation distance D has an upper limit. If the user holds their finger over the operation panel 15 at a position exceeding the upper limit of the operation distance D, the electrostatic capacitance at the operation position 6 of the user does not change, and the operation panel 15 makes no response to the operation of the user.

The detection area for objects is an area in mid-air that is about 3 cm away from the operation panel 15, for example. In other words, in response to the user moving the user's finger 3 close to a position about 3 cm from the operation panel 15, the electrostatic capacitance in the corresponding object changes and a contactless input is detected. The XYZ coordinates of the position in the detection area of the user's finger 3 are acquired as those of the operation position 6. In response to the user further moving the user's finger 3 to a position closer than 3 cm, the XYZ coordinates of the position are acquired.

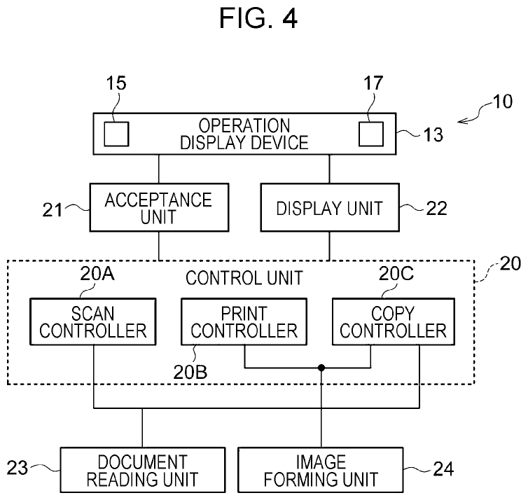

FIG. 4 is a diagram illustrating an example functional configuration of the image processing apparatus 10 according to the present exemplary embodiment. The image processing apparatus 10 includes functional units, namely, a control unit 20, an acceptance unit 21, a display unit 22, a document reading unit 23, and an image forming unit 24.

The acceptance unit 21 accepts a user ID of a user who operates the image processing apparatus 10 from the reader device 17 of the operation display device 13, and also accepts the operation position 6 of the user on the operation panel 15 from the operation panel 15 of the operation display device 13. The acceptance unit 21 further accepts image data from a portable storage medium connected to the terminal 4 of the user or the image processing apparatus 10. The acceptance unit 21 notifies the control unit 20 of the user ID, the operation position 6 of the user, and the image data, which have been accepted.

When notified of the user ID by the acceptance unit 21, the control unit 20 performs an authentication process to determine whether the user represented by the user ID is a user (referred to as a “registered user”) permitted to use the image processing apparatus 10. When notified of the operation position 6 of the user on the operation panel 15 by the acceptance unit 21, the control unit 20 determines whether the object displayed at the operation position 6 of the user is selected in the screen 30 displayed on the operation panel 15, and executes a process associated in advance with the selected object. For example, if the object is a button 8 for starting the print function, the control unit 20 starts the print function to form an image represented by the image data accepted by the acceptance unit 21 on a recording medium.

Since the image processing apparatus 10 has the copy function, the print function, and the scan function, the control unit 20 includes a scan controller 20A that controls the scan function, a print controller 20B that controls the print function, and a copy controller 20C that controls the copy function. Any one of the scan controller 20A, the print controller 20B, and the copy controller 20C performs control in accordance with the content of the process associated with the object operated by the user. In one example, the image processing apparatus 10 may have a facsimile function. In this example, the control unit 20 includes a facsimile controller that controls the facsimile function.

When the operation performed by the user through the object is an operation related to the scan function, the scan controller 20A controls the document reading unit 23 to implement the scan function. When the operation performed by the user through the object is an operation related to the print function, the print controller 20B controls the image forming unit 24 to implement the print function. When the operation performed by the user through the object is an operation related to the copy function, the copy controller 20C controls the document reading unit 23 to generate image data of the document 11. Thereafter, the copy controller 20C controls the image forming unit 24 to form an image represented by the generated image data on a recording medium.

The document reading unit 23 drives the document reading device 12 under the control of the scan controller 20A and the copy controller 20C to, for example, transport each of the documents 11 placed on the document table 16A and generate image data of the transported document 11.

The image forming unit 24 drives the image forming device 14 under the control of the print controller 20B and the copy controller 20C to, for example, transport a recording medium stored in any of the storage trays 19 and form an image represented by the image data on the transported recording medium.

The display unit 22 displays, for example, a result of the authentication process performed on the user and a result of the process executed by the control unit 20 in response to the operation performed by the user through the object on the operation panel 15 in the operation display device 13 in accordance with an instruction from the control unit 20.

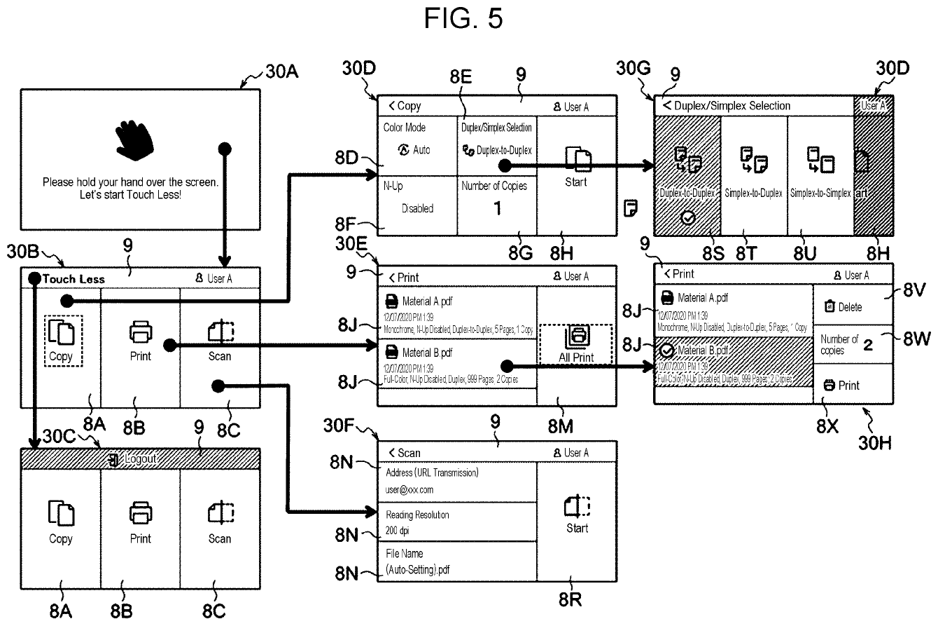

FIG. 5 is a diagram illustrating an example transition of the screen 30 displayed on the operation panel 15, presenting how the screen 30 transitions in response to the user operating the operation panel 15.

The display of the screen 30 on the operation panel 15, which is performed by the display unit 22, may also be interpreted as the display of the screen 30 on the operation panel 15 under the control unit 20 because the display unit 22 displays the screen 30 in accordance with an instruction from the control unit 20. A mid-air space extending along the Z axis and having a bottom surface corresponding to the display range of the screen 30 displayed on the operation panel 15 is expressed as a mid-air space “over the screen 30” or “above the screen 30”, and a mid-air space extending along the Z axis and having a bottom surface corresponding to the display range of an object displayed in the screen 30 is expressed as a mid-air space “over the object” or “above the object”. Like the expression “over the operation panel 15” or “above the operation panel 15”, the expression “over the screen 30” or “above the screen 30” and the expression “over the object” or “above the object” do not mean the upper side of the screen 30 and the upper side of the object based on the up, down, left, and right directions in the real space, respectively, but mean a mid-air space in a direction facing the screen 30 and a mid-air space in a direction facing the object, respectively.

For convenience of description, screens 30 whose types are distinguished from each other are accompanied by different alphabet symbols associated with the types of the screens 30. Screens 30 whose types are not distinguished from each other are collectively expressed as the “screens 30” regardless of their types. Buttons 8, which are an example of objects, whose types are distinguished from each other are accompanied by different alphabet symbols associated with the types of the buttons 8. Buttons 8 whose types are not distinguished from each other are collectively expressed as the “buttons 8” regardless of their types.

When it is determined that the user who performs an operation is a registered user through the authentication process, the control unit 20 causes a start screen 30A to be displayed on the operation panel 15. The start screen 30A displays an instruction given to the user, such as “Please hold your hand over the screen. Let's start Touch Less!”, for example.

When the user holds their finger over the start screen 30A, a cursor is displayed at the operation position 6 of the user on the start screen 30A. In the example of the start screen 30A illustrated in FIG. 5, a cursor in the shape of a hand is displayed. The shape of the cursor is an example, and, for example, a circular cursor may be displayed. In response to the user holding their finger over the start screen 30A, a home screen 30B is displayed. The instruction given to the user in the start screen 30A is also used to instruct the user how to perform an operation on the operation panel 15.

The home screen 30B displays, for example, buttons 8 for individually selecting the various functions of the image processing apparatus 10, and a navigation bar 9 for displaying information useful for the user to perform an operation. Since the image processing apparatus 10 has the copy function, the print function, and the scan function, a “Copy” button 8A for selecting the copy function, a “Print” button 8B for selecting the print function, and a “Scan” button 8C for selecting the scan function are displayed on the home screen 30B. The navigation bar 9 displays, for example, the name of a user who has been authenticated, such as “user A”, the name of a screen being displayed on the operation panel 15, such as “home”, and information for notifying the user that the operation panel 15 is in a contactless operation mode, such as “Touch Less”.

In response to the user holding their finger over the “Copy” button 8A, the “Copy” button 8A is selected. Upon selection of the “Copy” button 8A, a copy screen 30D is displayed on the operation panel 15. The copy screen 30D displays buttons 8D to 8G for setting copy conditions, and a copy start button 8H for starting copying under the set copy conditions.

The copy screen 30D illustrated in FIG. 5 displays, as an example of the buttons 8 for setting copy conditions, for example, a color mode button 8D for selecting a copy color, a duplex/simplex selection button 8E for selecting a double-sided (duplex) or single-sided (simplex) copy mode, an N-up button 8F for selecting an image layout on a recording medium, and a number-of-copies button 8G for selecting the number of copies to be made.

In response to the user holding their finger over any one of the buttons 8D to 8G for setting the respective copy conditions, the button 8 corresponding to the operation position 6 of the user is selected, and the screen 30 for setting the copy condition corresponding to the selected button 8 is displayed. In response to the duplex/simplex selection button 8E being selected on the copy screen 30D, a duplex/simplex selection screen 30G for selecting a duplex or simplex copy mode is displayed on the operation panel 15 in such a manner as to be superimposed on the copy screen 30D.

The duplex/simplex selection screen 30G illustrated in FIG. 5 displays, for example, a duplex-to-duplex selection button 8S for sequentially copying two-sided documents 11 on both sides of recording media, a simplex-to-duplex selection button 8T for sequentially copying one-sided documents 11 having text and the like on either side thereof on both sides of recording media, and a simplex-to-simplex selection button 8U for sequentially copying one-sided documents 11 having text and the like on either side thereof on either side of recording media.

In response to the user holding their finger over any one of the buttons 8S to 8U on the duplex/simplex selection screen 30G, the button 8 corresponding to the operation position 6 of the user is selected, and a copy mode corresponding to the selected button 8 is set. In the example of the duplex/simplex selection screen 30G illustrated in FIG. 5, the duplex-to-duplex selection button 8S is selected by the user.

In response to a duplex or simplex copy mode being set on the duplex/simplex selection screen 30G, the copy screen 30D is displayed on the operation panel 15. After the setting of the copy mode, the copy mode selected on the duplex/simplex selection screen 30G is displayed in the duplex/simplex selection button 8E on the copy screen 30D.

In the example described above, the user selects the duplex/simplex selection button 8E on the copy screen 30D. Also in response to the user selecting any one of the color mode button 8D, the N-up button 8F, and the number-of-copies button 8G on the copy screen 30D, a selection screen for selecting a copy condition corresponding to the selected one of the buttons 8 is displayed on the operation panel 15 in a manner similar to that for the duplex/simplex selection screen 30G.

In response to the user holding their finger over the copy start button 8H on the copy screen 30D, the copy start button 8H is selected. Upon selection of the copy start button 8H, a copying process for copying the content of the documents 11 on recording media is executed in accordance with the set copy conditions. Before the setting of the copy conditions, the buttons 8D to 8G on the copy screen 30D display initially set copy conditions that are set in advance.

In response to the user holding their finger over the “Print” button 8B on the home screen 30B, the “Print” button 8B is selected. Upon selection of the “Print” button 8B, a print screen 30E is displayed on the operation panel 15.

The print screen 30E displays print information buttons 8J each for displaying information on a piece of image data to be used for printing, and an all-print start button 8M for starting printing of all of the pieces of image data corresponding to the respective print information buttons 8J. In the example of the print screen 30E illustrated in FIG. 5, the print screen 30E in which two pieces of image data to be used for printing are accepted is illustrated. That is, the print screen 30E displays a number of print information buttons 8J equal to the number of pieces of image data accepted as targets for printing from the user, each print information button 8J corresponding to a corresponding one of the pieces of image data.

If the number of pieces of image data is too large to display the corresponding print information buttons 8J in the print screen 30E at the same time, in response to the user performing a gesture of moving their finger in an upward/downward direction of the print information buttons 8J, the operation panel 15 detects the movement of the operation position 6 and scrolls the print information buttons 8J. As a result, the print information buttons 8J that are not displayed in the print screen 30E are displayed in the print screen 30E.

Each of the print information buttons 8J displays a file name of image data to be used for printing and print conditions set by the user in advance for the image data. For example, when the user transmits image data from the terminal 4 to the image processing apparatus 10, print conditions set by the user using the terminal 4 are displayed in the print information button 8J.

In response to the user holding their finger over the all-print start button 8M, the all-print start button 8M is selected. Upon selection of the all-print start button 8M, a printing process for printing images represented by image data on recording media is executed in accordance with the set print conditions.

In response to the user holding their finger over any one of the print information buttons 8J, the print information button 8J over which the finger is held is selected. Upon selection of any one of the print information buttons 8J, a print edit screen 30H is displayed on the operation panel 15. The print edit screen 30H illustrated in FIG. 5 is displayed, for example, in response to the user selecting the print information button 8J corresponding to the image data representing “Material B.pdf”.

The print edit screen 30H displays, for example, a delete button 8V for deleting the image data corresponding to the selected print information button 8J, a change button 8W for changing a print condition of the image data corresponding to the selected print information button 8J, and an individual-print start button 8X for printing only the image data corresponding to the selected print information button 8J. The print edit screen 30H illustrated in FIG. 5 displays, as an example of the change button 8W, a change button 8W for changing the number of copies to be printed. The print edit screen 30H also displays, for example, a change button 8W (not illustrated) for changing any other print condition, such as the color of an image to be printed.

In response to the user holding their finger over the “Scan” button 8C on the home screen 30B, the “Scan” button 8C is selected. Upon selection of the “Scan” button 8C, a scan screen 30F is displayed on the operation panel 15.

The scan screen 30F displays scan setting buttons 8N for setting scan conditions, and a scan start button 8R for starting reading of the documents 11 in accordance with the set scan conditions.

In response to the user holding their finger over any one of the scan setting buttons 8N, the scan setting button 8N corresponding to the operation position 6 of the user is selected, and a selection screen (not illustrated) for selecting the scan condition corresponding to the selected scan setting button 8N is displayed. That is, the user sets each of the scan conditions associated with the scan setting buttons 8N in the same manner as the operation of setting the copy conditions through the copy screen 30D. In response to the user holding their finger over the scan start button 8R, the scan start button 8R is selected. Upon selection of the scan start button 8R, a scanning process for converting the content of the documents 11 into image data is executed in accordance with the set scan conditions.

In response to the user holding their finger over the navigation bar 9 on the home screen 30B, the navigation bar 9 is selected. Upon selection of the navigation bar 9, a logout process of the authenticated user is performed. Then, as illustrated in a screen 30C, and the navigation bar 9 displays an indication of completion of the logout process.

The foregoing describes an example in which any one of the buttons 8 is selected in response to the user holding their finger over the button 8. In a contactless operation, the user's finger, which is in contact with the operation panel 15, can move. If an object whose area includes the operation position 6 is simply set as an object selected by the user because the area includes the operation position 6, another object adjacent to the object that the user is intended to operate may be incorrectly selected if the user's finger unintentionally moves. In addition, the user may pass their finger over another object not to be operated while moving the finger to above the object to be operated, and the unintended object may be incorrectly selected.

Accordingly, for example, when the user continuously holds their finger over an object for a predetermined period of time (a certain amount of time), the object over which the finger is held may be determined to be an object intentionally selected by the user. In other words, when the operation position 6 of the user remains located in the area of a specific object on the operation panel 15 for a predetermined period of time (a certain amount of time), it may be determined that the user has selected the object. The predetermined period of time may be set to 3 seconds. However, this example is not limiting. For example, the predetermined period of time may be set to a time other than 3 seconds. The method for detecting the operation position 6 is not limited to a detection method using the operation panel 15, which is a capacitive touch panel. For example, the operation position 6 may be detected using a time-of-flight (ToF) camera or the like.

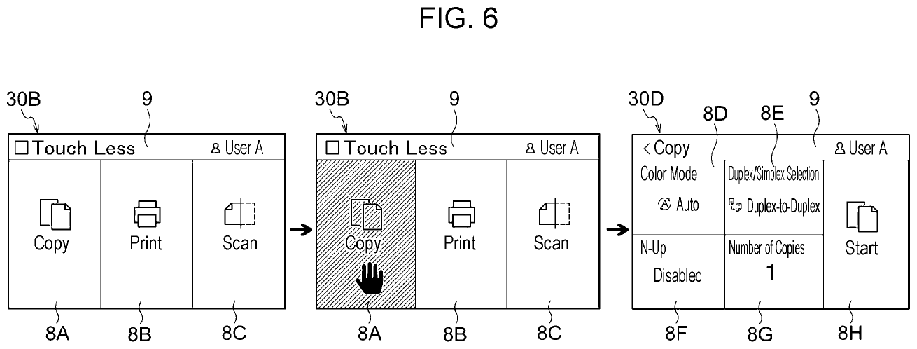

FIG. 6 is a diagram illustrating an example in which the user selects the “Copy” button 8A, which is an example of an object, on the home screen 30B.

In response to the user holding their finger over the “Copy” button 8A, the operation position 6 is detected within the area of the “Copy” button 8A. Such a transition from a state in which the operation position 6 has not been detected within the area of an object to a state in which the operation position 6 has been detected within the area of an object is referred to as “selection start”, “tentative selection”, or “hover”. An object has not yet been selected as long as the object is in the “selection start” state.

When the user continuously holds their finger over the “Copy” button 8A and the detected operation position 6 remains located within the area of the “Copy” button 8A for a predetermined period of time (a certain amount of time), as illustrated in FIG. 6, the “Copy” button 8A is selected, and the copy screen 30D is displayed on the operation panel 15. The confirmation of selection of an object is referred to as “selection completion” or “hold”. The completion of selection of an object is referred to as the object having been selected.

Accordingly, if the user's finger moves from over the “Copy” button 8A to another location during selection start, the selection start for the “Copy” button 8A is canceled. Such movement of the user's finger from over an object to another location during selection start is referred to as “deselection”. After an object is deselected, the user again continuously holds their finger over the deselected object for a predetermined period of time (a certain amount of time), thereby completing the selection of the deselected object.

Each of the objects in the screens 30 is associated in advance with a process to be executed in response to the selection of the object such that a copying process is executed in response to the selection of the copy start button 8H. To notify the user of the processes to be executed for the respective objects, each of the objects displays, for example, information indicating the content of the process to be executed in response to the selection of the object, such as “copy” for the copy start button 8H. The user understands a process associated with each of the objects by checking information indicating the content of the process to be executed in response to the selection of the object, that is, by checking an item associated with the object. As described above, the objects are displayed on the screens 30 in such a manner as to be associated with items each indicating the content to be processed. Accordingly, each of the objects is an example of an “item displayed on a screen” according to the present exemplary embodiment.

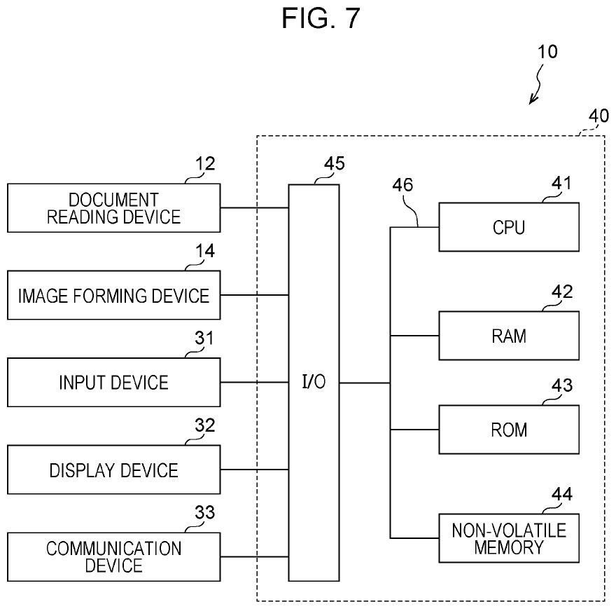

Next, the configuration of the substantial part of an electrical system of the image processing apparatus 10 will be described with reference to FIG. 7. The image processing apparatus 10 is implemented using, for example, a computer 40.

In the computer 40, a central processing unit (CPU) 41, a random access memory (RAM) 42, a read only memory (ROM) 43, a non-volatile memory 44, and an input/output interface (I/O) 45 are connected to each other via a bus 46.

The CPU 41 is an example of a processor configured to perform processing of the functional units of the image processing apparatus 10 illustrated in FIG. 4. The RAM 42 is an example of a storage medium to be used as a temporary work area for the CPU 41. The ROM 43 is an example of a storage medium that stores an information processing program to be executed by the CPU 41. The non-volatile memory 44 is an example of a storage medium configured such that information stored therein is maintained even if power supply to the non-volatile memory 44 is shut off. Examples of the non-volatile memory 44 include a semiconductor memory and a hard disk. The non-volatile memory 44 is not necessarily incorporated in the computer 40, and may be, for example, a storage medium attachable to the computer 40 in a removable manner, such as a memory card.

The I/O 45 is connected to, for example, the document reading device 12, the image forming device 14, an input device 31, a display device 32, and a communication device 33.

The document reading device 12 and the image forming device 14 are devices that perform operations as described above. The input device 31 is a device that notifies the CPU 41 of an instruction from the user and a user ID of the user in response to receipt of the instruction and the user ID. Examples of the input device 31 include a touch panel constituting the operation panel 15, and the reader device 17. The display device 32 is a device that visually displays information processed by the CPU 41. Examples of the display device 32 include a display constituting the operation panel 15. The communication device 33 is connected to the communication line 2 and has a communication protocol for communicating with the terminals 4. The devices connectable to the I/O 45 are not limited to the devices illustrated in FIG. 7. The I/O 45 may be connected to a device necessary for implementing a function in accordance with the functions of the image processing apparatus 10.

Since contactless operations are performed in mid-air, the user may incorrectly operate an unselected object different from an object that is in a selected state (i.e., an object for which selection is completed) if an operation for the unselected object is accepted.

To address this inconvenience, the image processing apparatus according to the present exemplary embodiment is configured to, when an object in a screen is to be operated with a user's finger in a contactless manner, accept an operation on the object that is in a selected state in response to the user's finger being located in a second region closer to the screen than a first region among a plurality of regions separated according to the distance from the screen. The first region is assigned an operation for selecting the object in the screen. The second region is assigned an operation on the object.

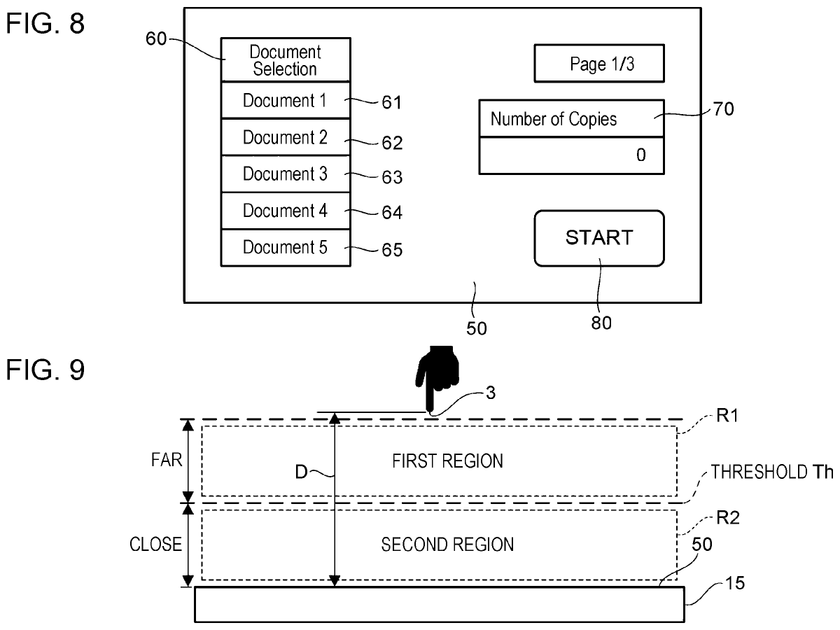

More specifically, as illustrated in FIGS. 8 and 9, in the image processing apparatus according to the present exemplary embodiment, the CPU 41 causes one or more objects to be displayed in a print screen 50 on the operation panel 15. In response to detecting the presence of the user's finger 3 in a first region R1, the CPU 41 accepts an operation for tentatively selecting an object in the print screen 50. Then, in response to detecting the movement of the user's finger 3 from the first region R1 to a second region R2 after the object is tentatively selected, the CPU 41 accepts an operation for the object tentatively selected with the user's finger 3 in the first region R1. That is, when the CPU 41 detects the movement of the user's finger 3 from the first region R1 to the second region R2 after the object is tentatively selected, the object tentatively selected with the user's finger 3 in the first region R1 is brought to selection completion (also referred to as “active state”), making a specific operation assigned to the object executable (or processable). In other words, when the user's finger 3 moves from the first region R1 and reaches the second region R2, the tentatively selected object is brought into a selected state (selection completion).

As illustrated in FIG. 9, in the present exemplary embodiment, the distance from the user's finger 3 to the print screen 50 (i.e., the operation distance D) is divided into two regions. Of the two regions, the region closer to the user's finger 3 is the first region R1, and the region closer to the print screen 50 than the first region R1 is the second region R2. The first region R1 and the second region R2 are separated by a threshold Th. The threshold Th is a threshold for the distance from the operation panel 15 to the user's finger 3, and is set to an appropriate value within a range not exceeding the distance at which the user's finger 3 is detectable. The operations to be assigned to the first region R1 and the second region R2 may be set as appropriate by the user.

Next, the display of the print screen 50 as an example of a screen on the operation panel 15 will be described in detail with reference to FIG. 8.

FIG. 8 is a plan view of the print screen 50 according to the present exemplary embodiment. FIG. 9 is a diagram schematically illustrating an example of regions in mid-air above the print screen 50 according to the present exemplary embodiment when the print screen 50 is viewed from a side.

The print screen 50 illustrated in FIG. 8 displays a document selection list 60, a number-of-copies setting button 70, and a print start button 80 as an example of objects.

The document selection list 60 is a list of pieces of printable document data. When the document selection list 60 is selected, each individual piece of listed document data is selectable. In the example illustrated in FIG. 8, the document selection list 60 has registered therein document data of documents 1 to 5. In FIG. 8, the documents 1 to 5 in the document selection list 60 are indicated by icon images 61 to 65, respectively. These pieces of document data may be held in the non-volatile memory 44 included in the image processing apparatus 10 or may be held in a terminal 4 connected via the communication line 2.

The number-of-copies setting button 70 is a button for inputting the number of copies to be printed. When the number-of-copies setting button 70 is selected, the number of copies to be printed can be set.

The print start button 80 is a button for executing the print function. When the print start button 80 is selected, a printing process is executed.

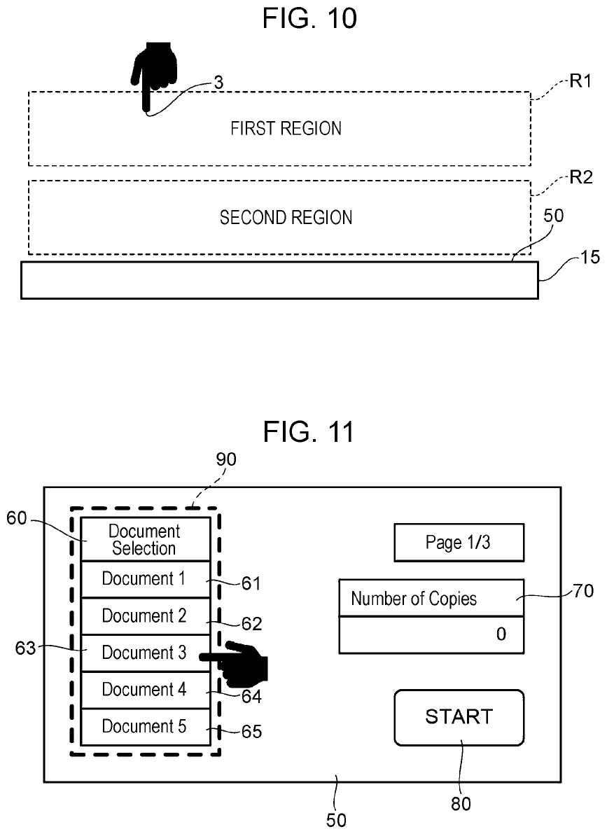

Next, an example of a contactless operation of the image processing apparatus 10 according to the present exemplary embodiment will be described with reference to FIGS. 10 to 23.

In the present exemplary embodiment, the first region R1 is assigned an operation for selecting an object, and the second region R2 is assigned an operation on an object that is in a selected state. The operation on an object, which is assigned to the second region R2, is an operation specific to the object.

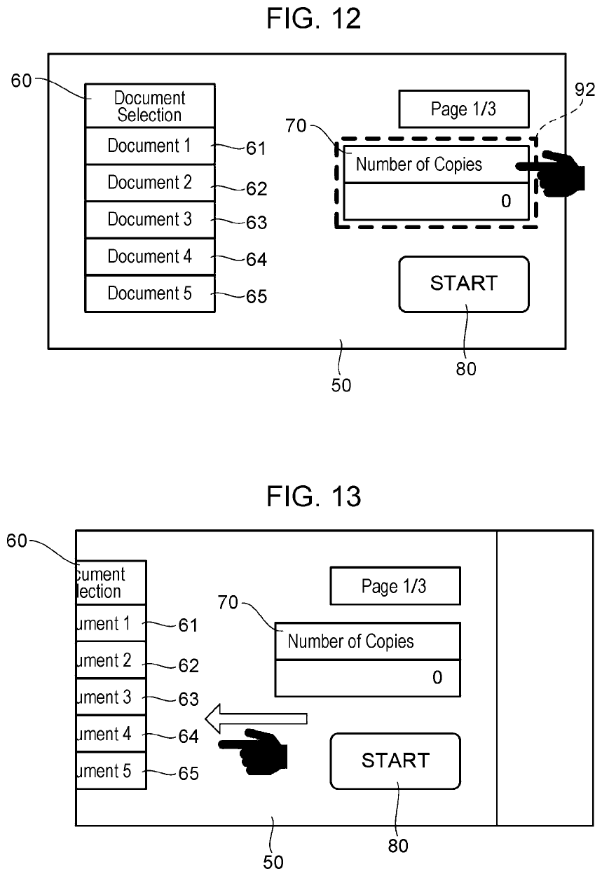

First, an operation for selecting an object will be described with reference to FIGS. 10 to 13. FIG. 10 is a side view corresponding to FIG. 9, illustrating a state in which the user's finger 3 serving as a target used for contactless operation is present in the first region R1 above the print screen 50. FIG. 11 is a front view corresponding to FIG. 8, illustrating a state in which the document selection list 60 serving as an object in the print screen 50 is tentatively selected. FIG. 12 is a front view corresponding to FIG. 8, illustrating a state in which the number-of-copies setting button 70 serving as another object in the print screen 50 is tentatively selected. FIG. 13 is a front view corresponding to FIG. 8, illustrating a page switching operation serving as an operation for changing the print screen 50 to the next page.

As illustrated in FIG. 10, in response to detecting the user's finger 3 over the print screen 50, the CPU 41 determines the region where the user's finger 3 is located. In response to determining that the user's finger 3 is present in the first region R1, the CPU 41 accepts an operation for selecting an object in the print screen 50. The selection operation for the first region R1 is an operation of, first, moving the user's finger 3 to a position in the first region R1 above an object to be used among a plurality of objects to tentatively select the object, and then, moving the user's finger 3 from the first region R1 to the second region R2 to change tentative selection to selection completion.

In the present exemplary embodiment, when the user's finger 3 is present in the first region R1, the CPU 41 accepts a tentative selection of any one of the document selection list 60, the number-of-copies setting button 70, and the print start button 80 displayed in the print screen 50.

As illustrated in FIG. 11, in response to detecting the presence of the user's finger 3 at a position in the first region R1 above the document selection list 60, the CPU 41 tentatively selects the document selection list 60. When an object is tentatively selected, the CPU 41 may display a frame around the tentatively selected object. Specifically, in response to detecting the user's finger 3 at a position in the first region R1 above an area displaying the document selection list 60 (i.e., the operation position 6 (see FIGS. 3A and 3B)), the CPU 41 tentatively selects the document selection list 60 and may display a frame 90 around the document selection list 60.

As illustrated in FIG. 12, in response to detecting the movement of the user's finger 3 from the position in the first region R1 above the document selection list 60 to a position in the first region R1 above the number-of-copies setting button 70, the CPU 41 tentatively selects the number-of-copies setting button 70. In response to detecting the user's finger 3 at a position in the first region R1 above an area displaying the number-of-copies setting button 70, the CPU 41 tentatively selects the number-of-copies setting button 70 and may display a frame 92 around the number-of-copies setting button 70.

In response to detecting the movement of the user's finger 3 from the position in the first region R1 above the document selection list 60 to a position in the first region R1 above the print start button 80, the CPU 41 tentatively selects the print start button 80. In response to detecting the user's finger 3 at a position in the first region R1 above an area displaying the print start button 80, the CPU 41 tentatively selects the print start button 80 and may display a frame (not illustrated) around the print start button 80.

Further, as illustrated in FIG. 13, when the print screen 50 continues to the next page, the CPU 41 may assign, to the first region R1, an operation for changing (e.g., scrolling) the print screen 50 to the next page. In response to detecting that the user's finger 3 remains located in the first region R1 for a predetermined amount of time, the CPU 41 accepts an operation for changing the print screen 50 to the next page. In the example illustrated in FIG. 13, the CPU 41 accepts a scroll operation in response to detecting the user's finger 3 at a position other than the positions above the objects such as the document selection list 60, the number-of-copies setting button 70, and the print start button 80. Alternatively, the CPU 41 may accept an operation for changing the print screen 50 to the next page even in response to detecting the user's finger 3 at a position above any one of the objects such as the document selection list 60, the number-of-copies setting button 70, and the print start button 80.

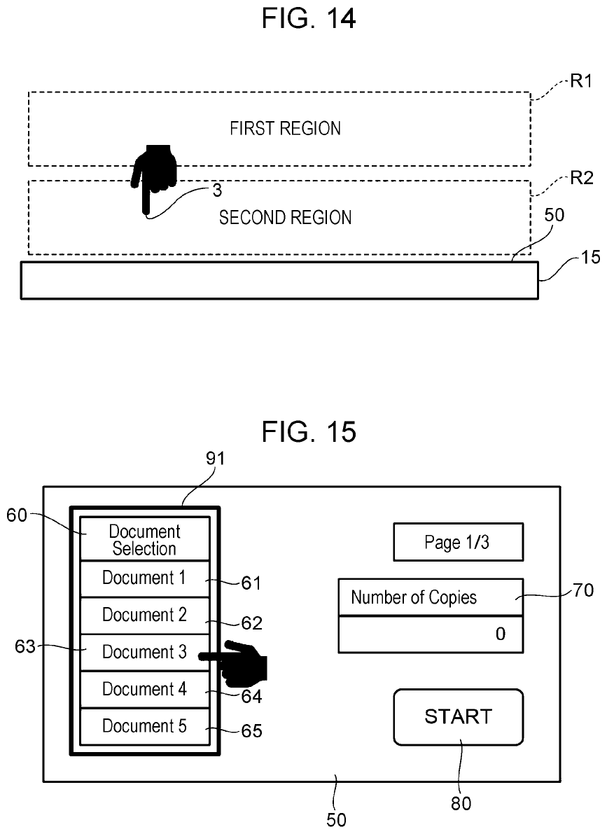

Then, in response to detecting the movement of the user's finger 3 from the first region R1 to the second region R2 (see FIG. 14) after the document selection list 60 is tentatively selected (see FIG. 11), the CPU 41 places the document selection list 60 into the active state and accepts an operation on the document selection list 60. When the document selection list 60 is placed into the active state, each individual piece of listed document data is individually selectable. In the method for selecting a piece of listed document data, for example, when the user's finger 3 continuously remains located above an area of an icon image indicating any document data for a predetermined amount of time (a certain amount of time), the target document data may be selected.

In response to detecting the movement of that the user's finger 3 to the second region R2 after the frame 90 is displayed around the document selection list 60 (i.e., tentatively selected state), as illustrated in FIG. 15, the CPU 41 may change the color of a frame 91 to indicate that the selection of the document selection list 60 is completed. In the present exemplary embodiment, the frame 90 (broken line) is displayed in blue, for example, and the frame 91 (solid line) is displayed in red, for example. The colors of the frames are not limited to those described above. Further, the change in display is not limited to the change in color as long as the frame 90 is changed to the frame 91, which is different in display from the frame 90, when the document selection list 60 is brought from the tentatively selected state to the selected state. For example, the frame 90 and the frame 91 may be different in line type, line thickness, or line shape.

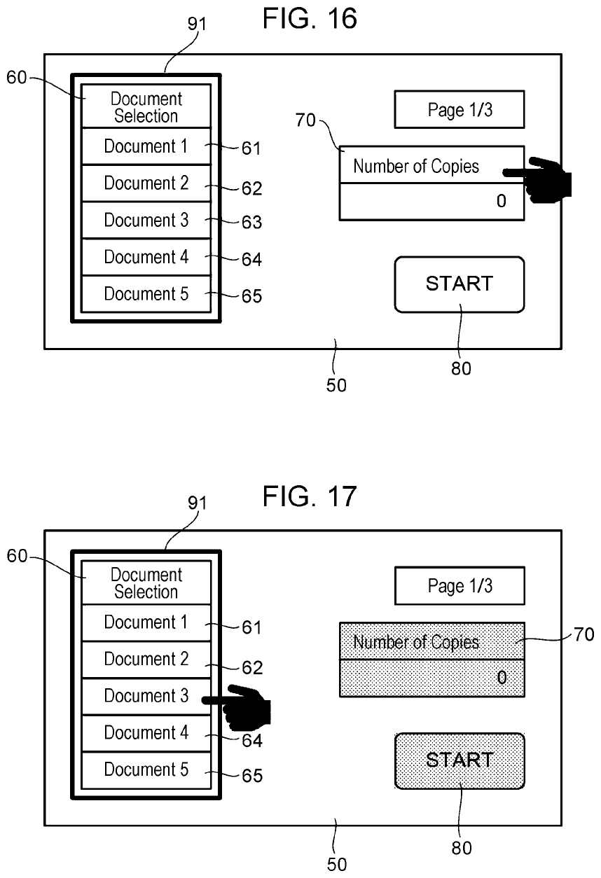

Further, as illustrated in FIG. 16, even in response to detecting the user's finger 3 at a position above an unselected object, namely, the number-of-copies setting button 70 or the print start button 80, when the user's finger 3 is present in the second region R2, the CPU 41 does not accept an operation for selecting such an unselected object.

Further, as illustrated in FIG. 17, the CPU 41 may change the color of the unselected objects, namely, the number-of-copies setting button 70 and the print start button 80, when the user's finger 3 is located in the second region R2. Changing the color of the unselected objects allows the user to recognize that the operation for selecting the objects whose color has been changed is not accepted.

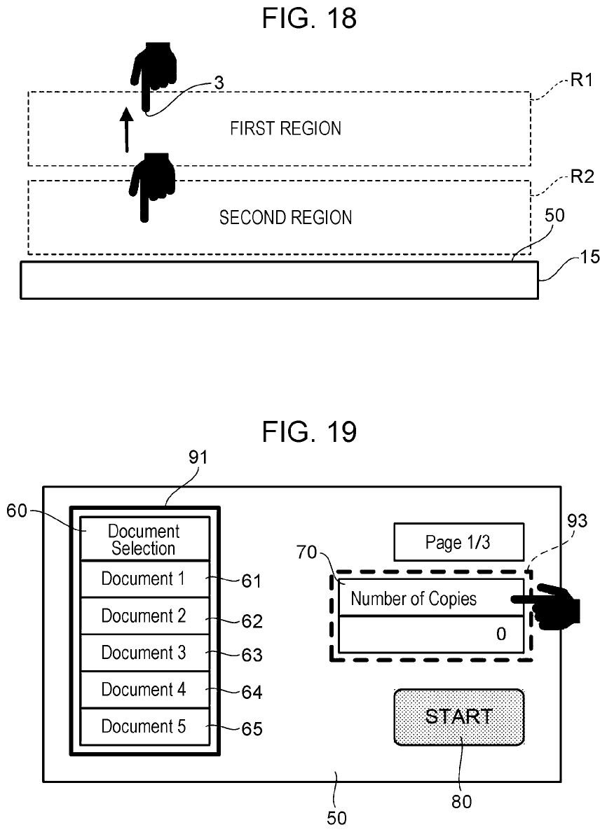

Further, as illustrated in FIG. 18, in response to detecting the movement of the user's finger 3 from the second region R2 to the first region R1 after the document selection list 60 is selected, the CPU 41 may again accept an operation for selecting the number-of-copies setting button 70 and the print start button 80 with the user's finger 3 in the first region R1. In the present exemplary embodiment, the CPU 41 may be configured not to cancel the selected state of the document selection list 60 even in response to detecting the movement of the user's finger 3 from the second region R2 to the first region R1 and configured to allow the user to continue the operation on the document selection list 60 in response to detecting the movement of the user's finger 3 from the first region R1 back to the second region R2. By contrast, the CPU 41 may be configured to cancel the selected state of the document selection list 60 when the movement of the user's finger 3 from the second region R2 to the first region R1 is detected and the user's finger 3 is detected at a position above another object to complete the selection of the other object. FIG. 19 illustrates a state in which the user's finger 3 moves from the second region R2 to the first region R1 after the document selection list 60 is selected, and then the user's finger 3 moves to a position above the number-of-copies setting button 70 to tentatively select the number-of-copies setting button 70. In response to detecting the movement of the user's finger 3 from the first region R1 to the second region R2 with the user's finger 3 remaining above the number-of-copies setting button 70, the CPU 41 completes the selection of the number-of-copies setting button 70 to selection completion.

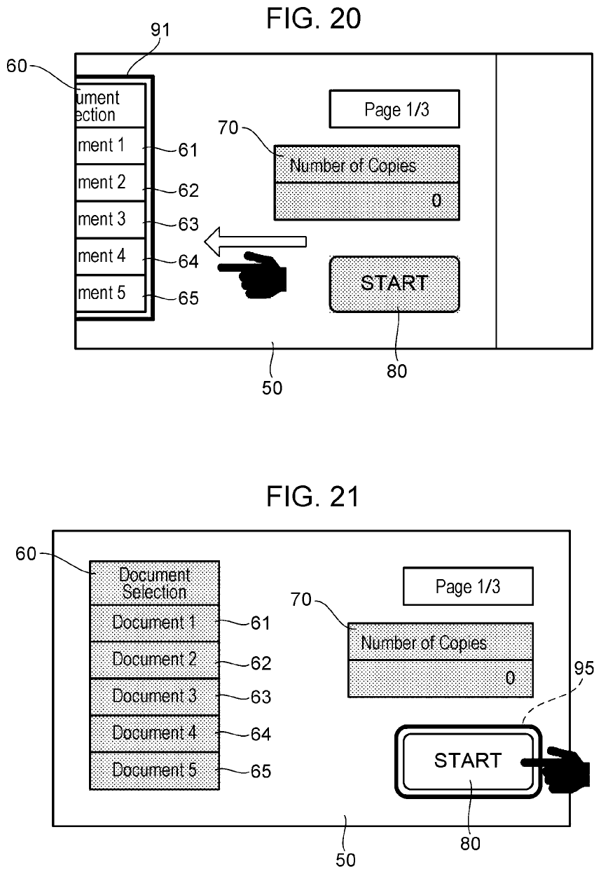

Further, as illustrated in FIG. 20, in response to detecting the user's finger 3 at a position above an unselected object, namely, the number-of-copies setting button 70 or the print start button 80, for a predetermined amount of time while the user's finger 3 is detected in the second region R2, the CPU 41 may bring the unselected object, namely, the number-of-copies setting button 70 or the print start button 80, to the selected state and accept an operation on the number-of-copies setting button 70 or the print start button 80, which is brought into the selected state.

As illustrated in FIG. 20, furthermore, in response to detecting the movement of the user's finger 3 from the second region R2 to the first region R1, the CPU 41 may accept an operation for scrolling the print screen 50. When the operation of scrolling the print screen 50 is executed, the CPU 41 may cancel the selected state of the document selection list 60.

Further, as illustrated in FIG. 21, in response to detecting the user's finger 3 at a position above the print start button 80, which is an unselected object, for a predetermined amount of time when the user's finger 3 is present in the second region R2, the CPU 41 may cancel the selected state of the document selection list 60 and brings the print start button 80, which is unselected, into a selected state. Then, the CPU 41 may accept an operation on the print start button 80 brought into the selected state.

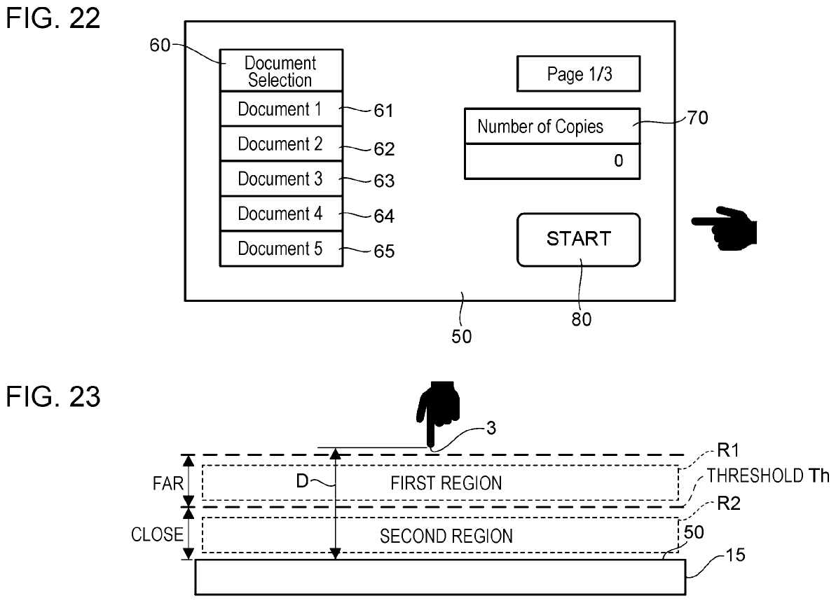

Further, as illustrated in FIG. 22, in response to the user moving the user's finger 3 to a position above the print screen 50 from one side to another of the print screen 50, the CPU 41 may divide the mid-air space from the user's finger 3 to the print screen 50 into the first region R1 and the second region R2 even if the distance from the user's finger 3 to the print screen 50 (i.e., the operation distance D (see FIG. 23)) is insufficient. Further, the CPU 41 may cause information to be displayed on the print screen 50 if the operation distance D is shorter than a predetermined threshold. The information to be displayed on the print screen 50 may be text or an image indicating that the user's finger 3 is too close to the print screen 50.

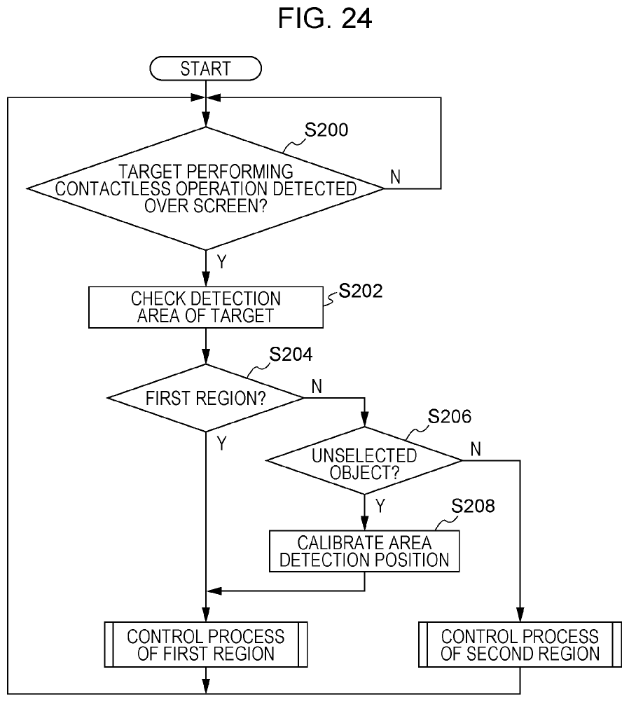

Next, the operation of the image processing apparatus 10 will be described with reference to FIG. 24.

FIG. 24 is a flowchart illustrating an example of a process based on an information processing program according to the present exemplary embodiment.

First, in response to an instruction to execute a contactless input through the operation panel 15, the CPU 41 activates the information processing program and executes the steps described below.

Referring to FIG. 24, in step S200, the CPU 41 determines whether the user's finger 3, which is a target performing a contactless operation, has been detected over the print screen 50. If the user's finger 3 has not been detected, the processing of step S200 is repeatedly performed after a predetermined amount of time has elapsed. If the user's finger 3 has been detected, the process proceeds to step S202.

In step S202, the detection area of the user's finger 3 is checked. Specifically, the operation distance D of the user's finger 3 is determined.

In step S204, the CPU 41 determines, based on the operation distance D of the user's finger 3, whether the user's finger 3 is present in the first region R1. If the user's finger 3 is present in the first region R1, the CPU 41 performs a control process of the first region R1, that is, a process associated with the operation assigned to the first region R1. When the control process of the first region R1 is completed, the process proceeds to step S200. If the user's finger 3 is not present in the first region R1, the process proceeds to step S206.

In step S206, the CPU 41 determines whether an object in the print screen 50 is selected. If no object is selected, the process proceeds to step S208. On the other hand, if an object is selected, the CPU 41 performs a control process of the second region R2, that is, a process associated with the operation assigned to the second region R2. When the control process of the second region R2 is completed, the process proceeds to step S200.

In step S208, the CPU 41 adjusts an area detection position of the user's finger 3 and then performs the control process of the first region R1. When the control process of the first region R1 is completed, the process proceeds to step S200.

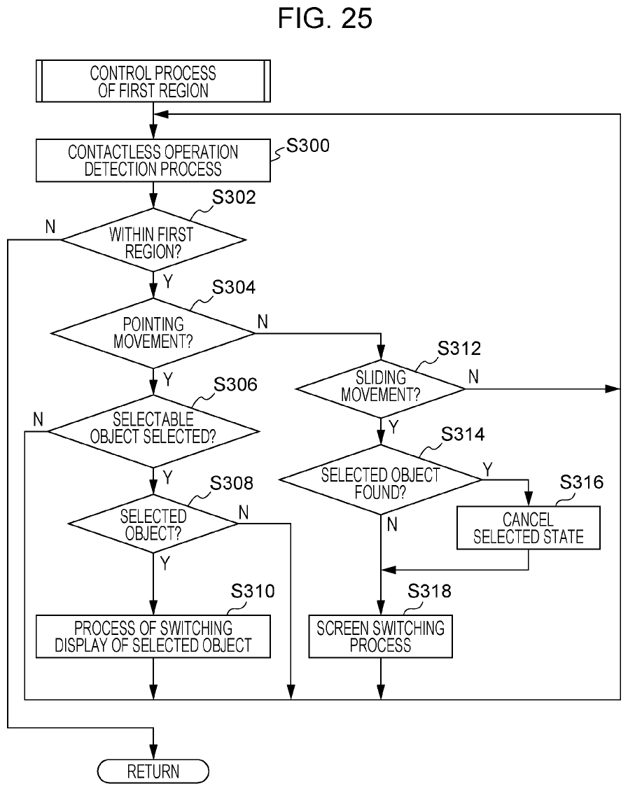

Next, the control process of the first region R1 will be described with reference to FIG. 25.

The control process of the first region R1 is started during the process illustrated in FIG. 24.

First, in step S300, the CPU 41 performs a process of detecting a contactless operation. Then, the process proceeds to step S302.

In step S302, the CPU 41 determines whether the user's finger 3 is within the first region R1. If the user's finger 3 is out of the first region R1, the control process of the first region R1 ends, and the process returns to the process illustrated in FIG. 24. On the other hand, if the user's finger 3 is within the first region R1, the process proceeds to step S304.

In step S304, the CPU 41 determines whether the operation of the user's finger 3 in the first region R1 is a pointing movement. If the operation of the user's finger 3 is a pointing movement, the process proceeds to step S306. If the operation of the user's finger 3 is not a pointing movement, the process proceeds to step S312. The pointing movement is an operation for moving the user's finger 3 within the first region R1 to select an object in the screen.

In step S306, the CPU 41 determines whether a selectable object is selected. If a selectable object is selected, the process proceeds to step S308. If a selectable object is not selected, the process proceeds to step S300.

In step S308, the CPU 41 determines whether a selected object is selected. If a selected object is selected, the process proceeds to step S310. If a selected object is not selected, the process proceeds to step S300.

In step S310, the CPU 41 performs a process of switching display of the selected object. Specifically, the CPU 41 displays a frame around the selected object. After that, the process proceeds to step S300.

In step S312, the CPU 41 determines whether the operation of the user's finger 3 in the first region R1 is a sliding movement. If the operation of the user's finger 3 is a sliding movement, the process proceeds to step S314. If the operation of the user's finger 3 is not a sliding movement, the process proceeds to step S300.

In step S314, the CPU 41 determines whether a selected object is found. If no selected object is found, the process proceeds to step S318. If a selected object is found, the process proceeds to step S316.

In step S316, the CPU 41 deselects the selected object. Then, the process proceeds to step S318.

In step S318, the CPU 41 determines that the operation of the user's finger 3 is an operation for scrolling the print screen 50, and performs a screen switching process. After that, the process proceeds to step S300.

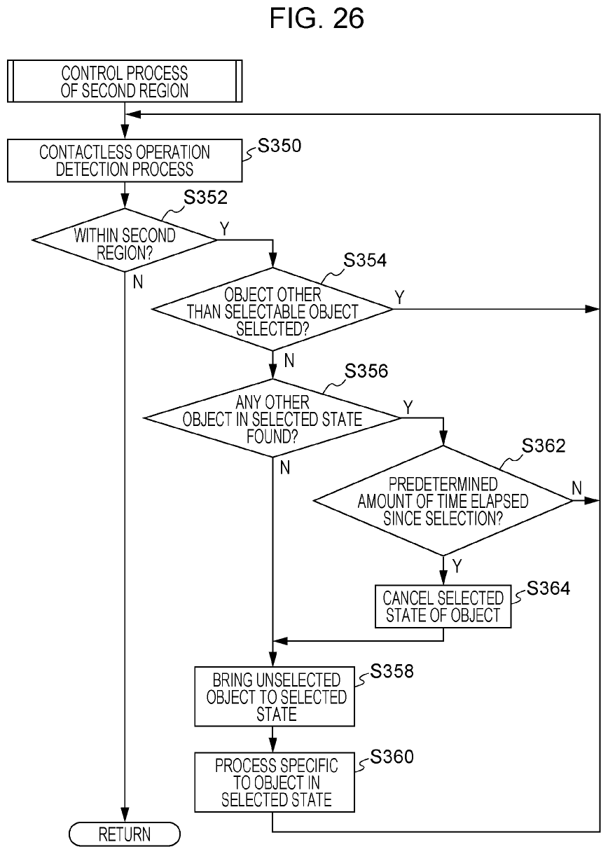

Next, the control process of the second region R2 will be described with reference to FIG. 26.

The control process of the second region R2 is started during the process illustrated in FIG. 24.

First, in step S350, the CPU 41 performs a process of detecting a contactless operation. Then, the process proceeds to step S352.

In step S352, the CPU 41 determines whether the user's finger 3 is within the second region R2. If the user's finger 3 is out of the second region R2, the control process of the second region R2 ends, and the process returns to the process illustrated in FIG. 24. On the other hand, if the user's finger 3 is within the second region R2, the process proceeds to step S354.

In step S354, the CPU 41 determines whether an object other than a selectable object is selected. If an object other than a selectable object is selected, the process proceeds to step S350. If no object other than a selectable object is selected, the process proceeds to step S356.

In step S356, the CPU 41 determines whether any other object that is in a selected state is found. If no other object that is in a selected state is found, the process proceeds to step S358. If any other object that is in a selected state is found, the process proceeds to step S362.

In step S358, the CPU 41 brings an unselected object to a selected state. After that, the process proceeds to step S360.

In step S360, the CPU 41 performs a process specific to the object that is in a selected state. After that, the process proceeds to step S350.

In step S362, the CPU 41 determines whether a predetermined amount of time has elapsed since the object was selected. If the predetermined amount of time has elapsed, the process proceeds to step S364. If the predetermined amount of time has not elapsed, the process proceeds to step S350.

In step S364, the CPU 41 cancels the selected state of the object. After that, the process proceeds to step S358.

In the way described above, the image processing apparatus 10 controls the contactless operation.

In the present exemplary embodiment, as described above, when the user's finger 3 is present in the second region R2, the CPU 41 accepts an operation on an object as long as the object is selected with the user's finger 3 in the first region R1. Thus, the object is less likely to be operated by mistake than when, for example, an operation on an object that is not selected with the user's finger 3 in the first region R1 is accepted while the user's finger 3 is located in the second region R2. The operation for completing the selection of an object is an operation for moving the user's finger 3 from the first region R1 to the second region R2 and is different from an operation for keeping the user's finger 3 at a certain position in the first region R1, such as a scroll operation for changing the screen to the next page. Thus, the object is less likely to be operated by mistake when the user's finger 3 is present in the first region R1. In addition, when an object is in a tentatively selected state, a frame is displayed around the object, which makes it easy to visually check the tentatively selected state.

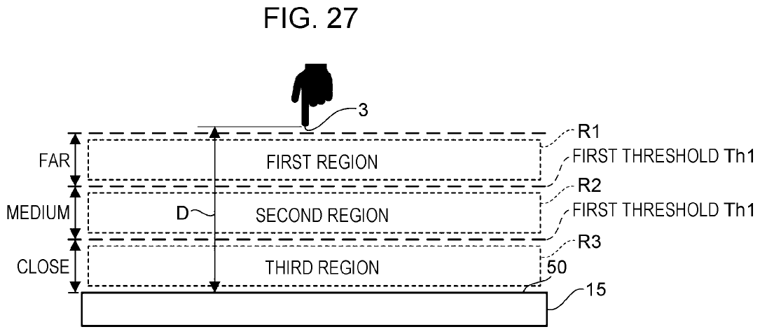

In the exemplary embodiment described above, the mid-air space between the user's finger 3 and the print screen 50 is divided into two regions. However, the present disclosure is not limited to this configuration. The mid-air space between the user's finger 3 and the print screen 50 may be divided into three or more regions, for example. FIG. 27 illustrates three regions into which the mid-air space is divided. In a case where the space is divided into three regions including a first region R1, a second region R2, and a third region R3 by a first threshold Th1, document data in the document selection list 60 may be selected with the user's finger 3 in the second region R2, and an operation on an image of the selected document data may be completed in response to the movement of the user's finger 3 from the second region R2 to the third area R3.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

An image processing apparatus has been described as an example of an information processing apparatus according to an exemplary embodiment. Exemplary embodiments may provide a program for causing a computer to execute the functions of the information processing apparatus. Exemplary embodiments may provide a non-transitory computer-readable storage medium storing such a program.

In addition, the configuration of an information processing apparatus described in the exemplary embodiment described above is an example and may be changed depending on the situation without departing from the scope of the present disclosure.

Additionally, a process flow of a program described in the exemplary embodiment described above is also an example, and any unnecessary step may be deleted, a new step may be added, or the processing order may be changed without departing from the scope of the present disclosure.

In the exemplary embodiment described above, a program is executed to implement processing according to an exemplary embodiment by a software configuration using a computer, by way of example but not limitation. The exemplary embodiment may be implemented by, for example, a hardware configuration or a combination of a hardware configuration and a software configuration.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
a processor configured to:
when an object in a screen is to be operated with a target in a contactless manner, accept an operation on the object that is in a selected state in response to the target being located in a second region closer to the screen than a first region among a plurality of regions separated according to a distance from the screen, the first region being assigned an operation for selecting the object in the screen, the second region being assigned an operation on the object.
   (((2)))

The information processing system according to (((1))), wherein the processor is configured to display a frame around the object in response to detecting the target at a position in the first region above the object.

(((3)))

The information processing system according to (((2))), wherein the processor is configured to, in response to movement of the target to the second region after the frame is displayed around the object, bring the object having the frame displayed therearound into the selected state and change a color of the frame.

(((4)))

The information processing system according to any one of (((1))) to (((3))), wherein
the object in the screen comprises a plurality of objects, and
the processor is configured to change a color of an unselected object among the plurality of objects.
   (((5)))

The information processing system according to any one of (((1))) to (((3))), wherein
the object in the screen comprises a plurality of objects, and
the processor is configured to, in response to movement of the target from the second region to the first region after an object among the plurality of objects is brought into the selected state, again accept selection of the object with the target in the first region.
   (((6)))

The information processing system according to any one of (((1)) to ((3))), wherein
the object in the screen comprises a plurality of objects, and
the processor is configured to, in response to detecting the target at a position in the second region above an unselected object among the plurality of objects for a predetermined amount of time, bring the unselected object into the selected state and accept an operation on the object brought into the selected state.
   (((7)))

The information processing system according to any one of (((1))) to (((6))), wherein
the processor is configured to, in response to detecting the target over the screen, divide a mid-air space from a position of the detected target to the screen into regions including the first region and the second region.
   (((8)))

The information processing system according to (((7))), wherein
the processor is configured to cause information to be displayed on the screen when a distance from the position of the detected target to the screen is shorter than a predetermined threshold.
   (((9)))

The information processing system according to any one of (((1))) to (((8))), wherein
the first region is assigned an operation for changing the screen, and
the processor is configured to accept the operation for changing the screen in response to detecting that the target remains located in the first region for a predetermined amount of time.
   (((10)))

The information processing system according to (((9))), wherein
the processor is configured to, in response to the operation for changing the screen after the object is brought into the selected state, cancel the selected state of the object.
   (((11)))

An information processing program for causing a computer to execute:
when an object in a screen is to be operated with a target in a contactless manner, accepting an operation on the object that is in a selected state in response to the target being located in a second region closer to the screen than a first region among a plurality of regions separated according to a distance from the screen, the first region being assigned an operation for selecting the object in the screen, the second region being assigned an operation on the object.

What is claimed is:

1. An information processing system comprising:
a processor configured to:
when an object in a screen is to be operated with a target in a contactless manner, accept an operation on the object that is in a selected state in response to the target being located in a second region closer to the screen than a first region among a plurality of regions separated according to a distance from the screen, the first region being assigned an operation for selecting the object in the screen, the second region being assigned an operation on the object.

2. The information processing system according to claim 1, wherein
the processor is configured to display a frame around the object in response to detecting the target at a position in the first region above the object.

3. The information processing system according to claim 2, wherein
the processor is configured to, in response to movement of the target to the second region after the frame is displayed around the object, bring the object having the frame displayed therearound into the selected state and change a color of the frame.

4. The information processing system according to claim 1, wherein
the object in the screen comprises a plurality of objects, and
the processor is configured to change a color of an unselected object among the plurality of objects.

5. The information processing system according to claim 1, wherein
the object in the screen comprises a plurality of objects, and
the processor is configured to, in response to movement of the target from the second region to the first region after an object among the plurality of objects is brought into the selected state, again accept selection of the object with the target in the first region.

6. The information processing system according to claim 1, wherein
the object in the screen comprises a plurality of objects, and
the processor is configured to, in response to detecting the target at a position in the second region above an unselected object among the plurality of objects for a predetermined amount of time, bring the unselected object into the selected state and accept an operation on the object brought into the selected state.

7. The information processing system according to claim 1, wherein
the processor is configured to, in response to detecting the target over the screen, divide a mid-air space from a position of the detected target to the screen into regions including the first region and the second region.

8. The information processing system according to claim 7, wherein
the processor is configured to cause information to be displayed on the screen when a distance from the position of the detected target to the screen is shorter than a predetermined threshold.

9. The information processing system according to claim 1, wherein
the first region is assigned an operation for changing the screen, and
the processor is configured to accept the operation for changing the screen in response to detecting that the target remains located in the first region for a predetermined amount of time.

10. The information processing system according to claim 9, wherein
the processor is configured to, in response to the operation for changing the screen after the object is brought into the selected state, cancel the selected state of the object.

11. A non-transitory computer readable medium storing a program causing a computer to execute a process for information processing, the process comprising:
when an object in a screen is to be operated with a target in a contactless manner, accepting an operation on the object that is in a selected state in response to the target being located in a second region closer to the screen than a first region among a plurality of regions separated according to a distance from the screen, the first region being assigned an operation for selecting the object in the screen, the second region being assigned an operation on the object.

12. An information processing method comprising:
when an object in a screen is to be operated with a target in a contactless manner, accepting an operation on the object that is in a selected state in response to the target being located in a second region closer to the screen than a first region among a plurality of regions separated according to a distance from the screen, the first region being assigned an operation for selecting the object in the screen, the second region being assigned an operation on the object.
